(19) United States
(12) Patent Application Publication
(10) Pub. No.: US 2020/0158747 A1
(43) Pub. Date: May 21, 2020

(54) Passive anti-vibration system for Inertial Measurement Unit (IMU) of Aerial vehicles

(71) Applicant: VIETTEL GROUP, Ha Noi City (VN)

(72) Inventors: VAN SU NGUYEN, An Thi District, Hung Yen Province (VN); HUNG CUONG TRAN, Ha Noi City (VN); TRONG DAI VU, Ha Noi City (VN); HUY NGUYEN, Ha Noi City (VN); VAN QUYEN PHAM, Y Yen District (VN)

(73) Assignee: VIETTEL GROUP, Ha Noi City (VN)

(21) Appl. No.: 16/679,387

(22) Filed: Nov. 11, 2019

(30) Foreign Application Priority Data
Nov. 15, 2018 (VN) 1-2018-05120

(51) Int. Cl. G01P 1/00; G01P 1/02

(52) U.S. Cl. CPC G01P 1/003; G01P 1/023

(57) ABSTRACT

As the potential applications of unmanned aerial vehicles (UAVs) are growing, more sensors are installed on-board. One of the most important on-board equipments is Inertial Measurement Unit (IMU). Mechanical vibration of the IMU, which greatly hinders the accuracy of its, becomes an increasingly important issue. In this specification, an anti-vibration framework on IMU is provided. A design process of an anti-vibration system of the IMU will be shown and described.

### TECHNICAL AREA

The invention refers to the design process of the passive anti-vibration system (PAVS) on the combination of the properties of the materials, the mechanism of IMU, signal analysis to optimize the position of IMU. The invention is applied in the aviation area.

### TECHNICAL STATUS OF THE INVENTION

Passive anti-vibration systems have been used for a long time and are used widely in industrial fields such as manufacturing, construction, automobiles and aviation. They are usually of different shapes and materials depending on the purpose of use in heavy or light industry. The common point of passive anti-vibration systems is not rigid, with the reason being subjected to deformation to absorb the force from vibration during the operation of the machine. The lifespan of passive anti-vibration systems depends on the operating environment, so it is possible to select the materials used in each different case. For example in heavy industry, passive anti-vibration components use steel materials in the form of twisted strands, or for signal acquisition equipments that require high precision, rubber materials are preferred. Some machines have a large vibration when operating, not only affecting the efficiency of work, but also being destroyed due to fatigue. The design of a passive anti-vibration system must be based on many factors such as working environment (humidity, chemicals, . . . ), requiring the accuracy of anti-vibration parameters (cut-off frequency, attenuation, etc.).

An Inertial Measurement Unit (IMU), is an electronic device that measures and reports in detail the angle, acceleration, and sometimes the magnetic field around a flying object. An IMU uses a combination of accelerometers and gyroscopes, sometimes with magnetometers. An IMU is often used to control aircraft, including Unmanned Aerial Vehicle (UAV), spacecraft, satellites and even surveillance ships. An IMU is a key component of the flight instrument's navigation system. With the ability of the IMU, the data collected from the sensors allows the computer to track the position of an object, using the “dead reckoning” method (the method of calculating the current position of an object by using a predefined, or fixed position, and estimating the position of an object based on speed over time and distance).

For aerial vehicles, during flight, due to external aerodynamic pressure acting on the body, engine vibration during operation may affect an IMU's ability to receive signals, causing disorientation and deviations in the trajectory.

The domestic and worldwide technology solutions currently being applied to the manufacture of anti-vibration systems include:
Gimbal anti-vibration for electronic parts: these solutions mainly focus on anti-vibration devices in the direction of the object's rotation. Thereby eliminating the torque acting on the object in 3 directions, increasing the ability of anti-vibration for details in 3 directions even when the vibration frequency is large. Due to the simple use of mechanical rotating mechanism, this method can be widely applied to many fields such as filming, photography.
Active anti-vibration for electronic parts: this solution mainly focuses on anti-vibration for details that require high accuracy, avoiding vibration-induced noise used in laboratories. The system consists of a frequency sensor and a vibration amplitude, which then transmits the signal to the control center unit. From here, the signal is analyzed and then transmitted to the motor that creates vibrations with the same frequency and amplitude opposite to the vibration amplitude from the outside to suppress the vibrations.

Therefore, the inventors disclose a passive vibration reduction system for the IMU and the method to design.

### TECHNICAL NATURE OF THE INVENTION

The first purpose of the present invention is to provide an anti-vibration system for an IMU in a given space limited by a box [1]. The system consists of two main parts: vibration-proof parts [2], centering weights [3], jigs [4] and inertial sensors [5] where:

The vibration-proof element is essentially a device designed with a stainless steel material located on the square base [6] and specially round rubber [7]. The anti-vibration element has high elastic characteristics, good heat resistance, damping coefficient and stiffness suitable to prevent vibration for the inertial sensor block, performing the anti-vibration function for the system according to the principle: dynamic balance of solid objects on the system of 6 degrees of freedom.

The box [1] is fastened together to create a space for design. Anti-vibration parts [2] are fastened to the wall of the box for fixation. Heavy weight [3] and heavy weight linker [4] are components that connect the vibration-proof element to the inertial sensor block [5], which is fastened, avoiding mechanical contamination as much as possible. When a mechanical vibration occurs, the mechanical element will vibrate inside the jig, affecting the sensor's signal for impact. From here, engineers can design the mounting components so that the weight is balanced at the center of the system, and tightly connected to the vibration-proof components through screws and bolts. The profile of the parts can affect the specific frequency of the structure, so it is necessary to design the jigs to avoid resonant frequencies with the vibration source such as the engine of the flying device or the outside environment.

The entire anti-vibration system is removable during use. Because after machining, sometimes processing errors occur, it is necessary to correct and redesign after testing on shock absorbers.

The second purpose of the present invention is to provide a method of designing anti-vibration system for inertial sensor blocks.

The design method includes the following steps: step 1: receive anti-vibration technical requirements for inertial sensor blocks, step 2: design anti-vibration jigs, step 3: select appropriate anti-vibration mounting.

At each step, the difference is:

Step 1: Receive Anti-Vibration Technical Requirements for Inertial Sensor Blocks

Receive IMU anti-vibration requests, learn and evaluate the values that directly affect each request, including: Space for designing anti-vibration systems: size of bags (cases); Desired cutoff frequency;

Step 2: Design Anti-Vibration Jigs.

This step should calculate the mass of the structure including the jigs, screws and sensor blocks and calculate the transfer function of the structure without vibration. Using input data includes: Space of the container; expected volume; central mass of the inertial sensor unit; shock/vibration spectrum.

Step 3: Select Suitable Anti-Vibration Mounting

This step needs to calculate the number of vibration-proof parts to use and choose the type of vibration reduction, based on the principle of minimizing the vibration effect on the inertial sensor block by balancing the elastic center of the system of anti-vibration elements with the central mass of the vibration-proof parts. Based on the output data of the previous step, we will parameterize all values to determine the vibration resistance to be used as axial stiffness; radial stiffness; Damper coefficient depends on the material.

### BRIEF DESCRIPTION OF THE FIGURES

FIG. 1: Overview of the design method of anti-vibration system.

FIG. 2: Overall anti-vibration system in the box on request.

FIG. 3: Assembly of an anti-vibration system.

FIG. 4: Anti-vibration element used in the system

FIG. 5: Description of cutoff frequency

FIG. 6: Description of disturbance time

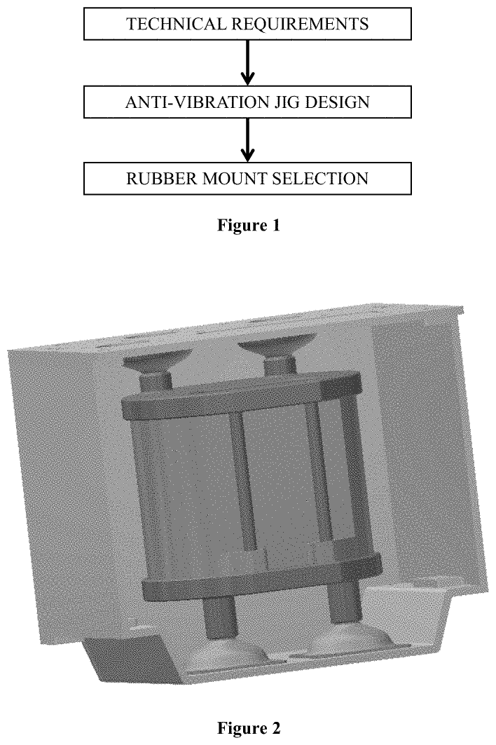

### DETAILED DESCRIPTION

The following describes in detail the passive anti-vibration system for the IMU inertial sensor block of flight instruments and the design of the anti-vibration system based on the interpretation, drawings and implementation example.

According to one implementation plan, the invention is to provide a passive anti-vibration system for the inertia sensor block in a given space limited by the box [1]. The system consists of the main parts: vibration-proof parts [2], centering weights [3], heavy-duty jigs [4] and inertial sensors [5] where:

The vibration-proof part [2] is actually a device designed with a stainless steel base on the square base [6] and specially round rubber [7]. High, good heat resistance, damping coefficient and stiffness suitable for anti-vibration for inertial sensor blocks, performing anti-vibration function for the system according to the principle of: dynamic equilibrium of a solid on 6 degrees of freedom.

The box [1] is fastened together to create a space for design. Anti-vibration parts [2] are fastened to the wall of the box for fixation. Heavy weight [3] and heavy weight linker [4] are components that connect the vibration-proof element to the inertial sensor block [5], which is fastened, avoiding mechanical contamination as much as possible. When a mechanical shock occurs, the mechanical element will vibrate inside the jig, affecting the sensor's signal for impact. From here, engineers can design the mounting components so that the weight is balanced at the center of the system, and tightly connected to the vibration-proof components through screws and bolts. The profile of the parts can affect the specific frequency of the structure, so it is necessary to design the jigs to avoid resonant frequencies with the vibration source such as the engine of the flying device or the outside environment.

Anti-vibration details in the invention plan perform the function of anti-vibration for the system according to the principle: Let the vibration-proof system to bring the sensor block to the equilibrium state as soon as possible. It is necessary to reduce vibration energy through cutting frequency. During the flight period of the instrument, the frequency range that the sensor unit is subjected to is up to 800 Hz, so the lower the cutoff frequency, the vibration energy of the external environment will no longer affect the sensor block. About the time of taking off, the frequency ranges from 0 Hz to 30 Hz and then over 30 Hz. Therefore, the cutoff frequency must be less than or equal to 30 Hz so that when starting to operate in the air, the energy from vibration will not affect much to the efficiency of the sensor.

Specifically, the anti-vibration process is expressed through calculations to align the appropriate mass for the system:

The weight of the system that needs anti-vibration is a variable in which the weight of the IMU has been determined based on the product specifications. So the variable to look for here is the weight of the jig, including bolts, screws, and steel or aluminum parts (depending on the specific weight of the material) that have anti-vibration links and inertial sensors. In the software design process, after placing materials on every detail, the software will determine the central position at the geometric center of the structure. Because some sensor blocks do not initially have the same center of gravity, the design will have to add or remove materials so that the center of gravity coincides with the geometry of the system.

To determine the position of anti-vibration compared to the entire structure, engineers must design appropriate jigs so that the average of the coordinates of each anti-vibration coincides with the center coordinates of the entire structure. including jigs and inertial sensor blocks. Preliminary calculation follows the formula below, where xg, yg, zg are the center coordinates of the structure, while x1, y1, z1 are the mount points of the first anti-vibration for the structure, n is the calculated vibration damping number.

$$\frac{{x}_{1} + {x}_{2} + … + {x}_{n}}{n} = {x}_{g}$$

$$\frac{{y}_{1} + {y}_{2} + … + {y}_{n}}{n} = {y}_{g}$$

$$\frac{{z}_{1} + {z}_{2} + … + {z}_{n}}{n} = {z}_{g}$$

According to one aspect of the implementation of the invention, the cutoff frequency is less than 50 Hz in accordance with the requirements given so that the vibration energy is attenuated after 50 Hz.

The jig is a part that connects the anti-vibration element with the inertial sensor block, which has a tight mounting structure, avoiding mechanical impurities as much as possible. When a mechanical shock occurs, the mechanical element will vibrate inside the jig, affecting the sensor's signal for impact. The transducer sensor unit is designed with round holes for assembling onto the jigs. From here, engineers can design the mounting components so that the weight is balanced at the center of the system, and tightly connected to the vibration-proof components through screws and bolts. The profile of the parts can affect the specific frequency of the structure, so it is necessary to design the jigs to avoid resonant frequencies with the vibration source such as the engine of the flying device or the outside environment.

Because it is designed specifically for the inertial sensor unit, these details have been calculated in the most appropriate way so that the whole structure system can achieve the best anti-vibration effect.

According to the plan to implement the first invention, the entire anti-vibration system is removable during use. Because after processing, sometimes errors occur when processing, one needs to correct and redesign, after testing on shock absorbers.

According to another implementation plan, the invention provides a method of designing anti-vibration system for inertial sensor blocks.

The design method in question includes the following steps:

Step 1: Receive anti-vibration technical requirements for inertial sensor blocks,

Step 2: Design anti-vibration jigs,

Step 3: Select suitable anti-vibration details

At each step, the difference is:

Step 1: Receive Anti-Vibration Technical Requirements for Inertial Sensor Blocks

Receive IMU anti-vibration requests, learn and evaluate the values that directly affect each request, including: Space for designing anti-vibration systems: size of bags (cases); Desired cutoff frequency; Desired interference time.

For the design of vibration-proof systems, this is the first requirement of the design of anti-vibration systems. This issue plays a very important role in the arrangement of anti-vibration elements, inertial sensor blocks and vibration-proof jars inside the system. Therefore, according to the design requirements, the anti-vibration system is installed in a pre-fixed space as a mounting frame integrated on the flying device. This will help the integration work easier, divide the tasks of each box methodically. Each jig box performs a different task on the flying device and so does the external jig.

Design space directly affects the calculation results to select the appropriate anti-vibration. The distance from the center of the system to each anti-vibration device must be specifically calculated to minimize the impact of vibration on the inertial sensor block. And the best option is the elastic center of the system of anti-vibration components coinciding with the center of the system to be anti-vibration, including the internal anti-vibration jig and the inertial sensor block.

For an overload affecting the anti-vibration system, when encountering a narrow space, the possibility of collision between the inertial sensor block and the jig box frame is possible, causing a signal that the sensor receives. Exceeding the limit results in an error or damage to the sensor. Meanwhile, to avoid collision between the details, the parameters of the anti-vibration part must also change, the narrower space in proportion to the anti-vibration must be harder so that the movement of the device block is reduced. Therefore, the anti-vibration design space plays a very important role in the technical requirements of the system.

The dimensions of the envelope are the input requirements of the design problem. Depending on the size of the box [1] given, engineers must install inertial sensor block appropriately and reasonably to resist vibration effectively.

For the desired cutoff frequency at that frequency, the resonant energy due to vibration is attenuated and has the least effect on the inertial sensor unit. The vibrating energy is attenuated to the region where the sensor is least affected. The cutoff frequency depends on the hardness, mass and damping coefficient of the entire vibration damping system. Therefore, the design of jigs and anti-vibration selection in the following steps directly affect this value.

As with the cutoff frequency, the interference time is also affected by the three values given above. The biggest effect is the damping coefficient of the system. This noise time indicates the delay of the actual signal compared to the desired signal. When the oscillation is small or large, it is proportional to the noise time, the oscillation at the small frequency is the low frequency, the oscillation at the high frequency, the greater the acceleration, the greater the latency, the need to effectively dampen the signal.

Step 2: Design Anti-Vibration Jigs.

This step should calculate the weight of the structure including the jigs, screws and sensor blocks and calculate the transfer function of the structure without vibration. Using input data includes: Space of the container; Expected volume; The central position of the inertial sensor unit; Shock vibration spectrum.

The calculation of the mass of a structure including fixtures, screws and sensor blocks is carried out as follows:

From the weight of each part, we can find the center of the structure to design the connection position between the structure and vibration-proof components.

The system is not too heavy, so the material used for the jigs is made of solid aluminum, so that the material properties do not change much after machining including hardness and damping coefficient of materials.

The distance between the jigs and containers is appropriately designed to avoid the impact of vibration

In many cases, the inertial sensor block has a center of gravity that is not centered in the object (geometric center), so the design aligns the jigs so that the center of the structure can be centered. geometrically. This will make anti-vibration more effective.

Calculation of transfer function of structure without vibration is performed as follows:

The transfer function is understood as the relationship between the input and output of a structure. The use of the vibration spectrum according to the aviation industry standard of flight equipment includes vibration frequency, vibration amplitude from which it is possible to calculate a value of energy transmitted into the structure. From this vibration spectrum, we will obtain the signal after the vibration from the output, we can calculate the transfer function of the structure. This transfer function helps us better understand the vibration characteristics of a structure. At this job, simulations using finite element theory are used to avoid damage to the equipment in the experimental field.

This step uses minimal input data that includes: Space of the container; Expected volume; The central position of the inertial sensor unit; Shock vibration spectrum.

The general principle of this step is as follows:

After using the design software, with material information and the size of each detail, the software can calculate the specific position of the focal position of the system. From here we can use the vibration spectrum to calculate the static and dynamic durability of details, in order to optimize the structure, reduce the mass of the structure.

Step 3: Design Anti-Vibration Jigs

This step should perform the calculation of the amount of anti-vibration details to use. Using input data including: transfer function of structure system after design; Weight of the structural system; Static and dynamic displacements of structures without vibration; Shock vibration spectrum.

At this step, the “center of the system” is understood as the average point according to the weight distribution of the object system. Also known as the “elastic center” of the anti-vibration system when the anti-vibration components are integrated into the system, these components are installed symmetrically at that point.

In the case of a system affected by overload in three directions, the system is only subject to external forces in three directions. In this case, the elastic center does not coincide with the center of the system, when overload occurs in three directions, the system will be subjected to an additional torque with the swing arm equal the distance between the elastic center of the limbs.

The distance from the center of the system to each anti-vibration device must be specifically calculated to minimize the impact of vibration on the inertial sensor block. And the best option is the elastic center of the system of anti-vibration components coinciding with the center of the system that needs anti-vibration.

According to one aspect of implementation, the number of anti-vibration components to use is four so that each part is symmetrical through the center (elastic center) of the system.

From the 6 free motion equations, we calculate the mass matrix [M] of the system as follows:

$$[ M ] = [ \begin{matrix}\begin{matrix}m & 0 & 0 \\ 0 & m & 0 \\ 0 & 0 & m\end{matrix} & 0 \\ 0 & \begin{matrix}{I}_{xx} & - {I}_{xy} & - {I}_{xz} \\ - {I}_{xy} & {I}_{yy} & - {I}_{yz} \\ - {I}_{xy} & - {I}_{yz} & {I}_{zz}\end{matrix}\end{matrix} ]$$

In which, m is the mass of the system including the inertial sensor block and the jig (the bolt, screw, and associated part), I is the value of the moment of inertia in the auxiliary xyz directions. depending on the material and profile of the structural system.

Since mass is a variable, it affects the dynamic properties of the structure, parameters and specific frequencies

[M][\ddot{q}]+[K][q]=0

Therein, [M] Mass matrix 6×6
[K] Stiffness matrix 6×6
[q] Displacement matrix 6×1
[q]=[x y z rotx roty rotz]^{T}
[q] Acceleration matrix 6×1

The K stiffness matrix includes the structural stiffness of every detail in a system including IMU

Simultaneously, constructing matrix I is the IMU's tensile inertial tensor matrix and jigs for Oxyz coordinate system to serve the theoretical calculation of hardness and damping coefficient for vibration.

$$[ I ] = [ \begin{matrix}{I}_{xx} & - {I}_{xy} & - {I}_{xz} \\ - {I}_{xy} & {I}_{yy} & - {I}_{yz} \\ - {I}_{xy} & - {I}_{yz} & {I}_{zz}\end{matrix} ] ( kg \cdot {m}^{2} )$$

At the end of this step, we obtain the transfer function of the structure after design; weight of the structural system; Static and dynamic displacements of structures without vibration.

Step 4: Choose the Appropriate Anti-Vibration Details

To choose the type of anti-vibration that should be used, depending on the material and structure of the anti-vibration device, the details have different hardness and damping coefficients. Based on the output data of the previous step, we will parameterize all values to determine the vibration resistance to be used such as: axial stiffness; radial stiffness; Damper coefficient depends on the material. As follows:

If n is called the total number of mounts used in the vibration damping design scheme. We have a hardness diagram of Mount s with coordinates [aₛ bₛ cₛ]^{T}

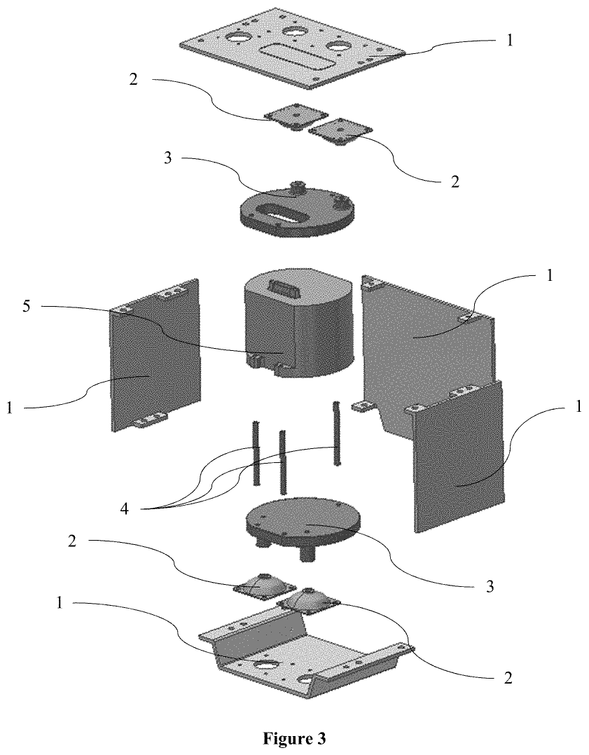

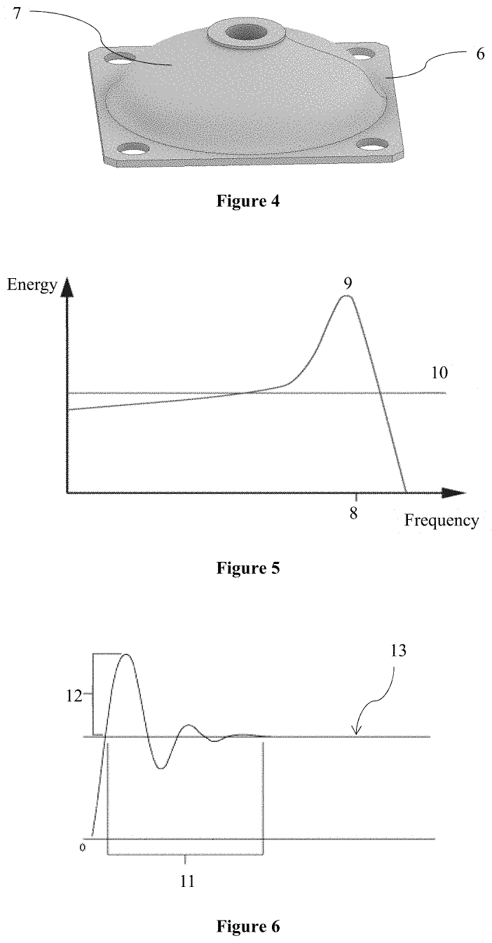

We have the Mount hardness matrix for the Sxyz coordinate system (Mount's elastic axis coordinate system), as shown in FIG. 3:

$$[ {K}_{Sxyz} ] = [ \begin{matrix}{K}_{Sx} & 0 & 0 \\ 0 & {K}_{Sy} & 0 \\ 0 & 0 & {K}_{sz}\end{matrix} ]$$

When calculating, the stiffness of Mount is compared to the Oxyz coordinate system in the center of IMU and the jigs.

$$[ {K}_{Oxyz} ] = [ \begin{matrix}{k}_{11}^{s} & {k}_{12}^{s} & {k}_{13}^{s} \\ {k}_{21}^{s} & {k}_{22}^{s} & {k}_{23}^{s} \\ {k}_{31}^{s} & {k}_{32}^{s} & {k}_{33}^{s}\end{matrix} ]$$

The index s in the matrix (4) indicates the order of Mount s

The formula converts the hardness matrix coordinate system from the Sxyz system to the Oxyz system

[K_{Oxyz}]=[T][K_{sxyz}][T]^{T}

[T]: The cosine matrix of Sxyz system compared to the Oxyz system.

[T]^{T}: Transform matrix of [T]

Mass Matrix [M]:

$$[ M ] = [ \begin{matrix}\begin{matrix}m & 0 & 0 \\ 0 & m & 0 \\ 0 & 0 & m\end{matrix} & 0 \\ 0 & \begin{matrix}{I}_{xx} & - {I}_{xy} & - {I}_{xz} \\ - {I}_{xy} & {I}_{yy} & - {I}_{yz} \\ - {I}_{xy} & - {I}_{yz} & {I}_{zz}\end{matrix}\end{matrix} ]$$

Stiffness Matrix[K]:

$$[ K ] = [ \begin{matrix}{k}_{11}^{s} & {k}_{12}^{s} & {k}_{13}^{s} & {k}_{14}^{s} & {k}_{15}^{s} & {k}_{16}^{s} \\ {k}_{21}^{s} & {k}_{22}^{s} & {k}_{23}^{s} & {k}_{24}^{s} & {k}_{25}^{s} & {k}_{26}^{s} \\ {k}_{31}^{s} & {k}_{32}^{s} & {k}_{33}^{s} & {k}_{34}^{s} & {k}_{35}^{s} & {k}_{36}^{s} \\ {k}_{41}^{s} & {k}_{42}^{s} & {k}_{43}^{s} & {k}_{44}^{s} & {k}_{45}^{s} & {k}_{46}^{s} \\ {k}_{51}^{s} & {k}_{52}^{s} & {k}_{53}^{s} & {k}_{54}^{s} & {k}_{55}^{s} & {k}_{56}^{s} \\ {k}_{61}^{s} & {k}_{62}^{s} & {k}_{63}^{s} & {k}_{64}^{s} & {k}_{65}^{s} & {k}_{66}^{s}\end{matrix} ]$$

Because Mount is made from rubber material, the Damper of rubber material is kind of Structural Shock.

Unlike Damping viscosity, Structural Damping force is proportional to displacement

f_{ds}=jαkq

Therein: α: Loss coefficient
k: Stiffness
q: Displacement
j=\sqrt{−1}.
f_{ds}: Structural damping force

The motion equation of the IMU is 6 degrees of freedom

[M][\ddot{q}]+(jα+1)[K][q]=(jα+1)[K][p]

Therein: [M] Mass matrix 6×6
[K] Stiffness matrix 6×6
[q] Displacement matrix of IMU 6×1
[\ddot{q}] Acceleration matrix 6×1
α Loss factor
[p] The excitation vibration matrix from the IMU base 6×1

Apply transformation (Convert to separate Vector space for calculation)

[q]=[Ø][η]

Therein: [Ø]: Separate Vector Matrix
[η] Vector of the major coordinates in the Vector space.

The equation has the following form:

[M][Ø][η]+(jα+1)[K][Ø][η]=(jα+1)[K][p]

Multiply 2 sides of equation (12) by the matrix [Ø]^{T}. We have the following equation

[Ø]^{T}[M][Ø][\ddot{η}]+(jα+1)[Ø]^{T}[K][Ø][η]=(jα+1)[Ø]^{T}[K][p]

Convert the above equation into the following form:

[Ø]^{T}[M][Ø][\ddot{η}]+(jα+1)[Ø]^{T}[K][Ø][η]=(jα+1)[Ø]^{T}[K][Ø][Ø]⁻¹[p]

Proved it:

$${[ Ø ]}^{T} [ K ] [ Ø ] = [ \begin{matrix}⋱ & 0 & 0 \\ 0 & {k}_{i} & 0 \\ 0 & 0 & ⋱\end{matrix} ] , {[ Ø ]}^{T} [ M ] [ Ø ] = {[ \begin{matrix}⋱ & 0 & 0 \\ 0 & {m}_{i} & 0 \\ 0 & 0 & ⋱\end{matrix} ] \\ [ Ø ]}^{- 1} [ p ] = [ F ] = [ \begin{matrix}⋮ \\ {F}_{i} \\ ⋮\end{matrix} ] , [ η ] = [ \begin{matrix}⋮ \\ {η}_{i} \\ ⋮\end{matrix} ]$$

The equation has the following form

mᵢ\ddot{η}ᵢ+(1+αj)kᵢηᵢ=(1+αj)kᵢFᵢ

Suppose that solutions have the form

ηᵢ=ηᵢe^{jωt}, Fᵢ=Fᵢe^{jωt}

The equation has the following form

{(kᵢ−ω²mᵢ)+jαkᵢ}ηᵢ=(1+αj)kᵢFᵢ

ωᵢ=\sqrt{kᵢ/mᵢ}, r=ω/ωᵢ

The equation has the following form

$${η}_{i} ( 1 + α j ) {F}_{i} / ( ( 1 - {r}^{2} ) + j α )$$

$$Real = \frac{{F}_{i} ( 1 - {r}^{2} + {η}^{2} )}{{( 1 - {r}^{2} )}^{2} + {( α )}^{2}} , Ima = - \frac{α {r}^{2} {F}_{i}}{{( 1 - {r}^{2} )}^{2} + {( α )}^{2}}$$

$$\frac{{η}_{i}}{{F}_{i}} = \frac{{\ddot{η}}_{i}}{{\ddot{F}}_{i}} = \sqrt{{Real}^{2} + {Ima}^{2}} = \sqrt{\frac{1 + {α}^{2}}{{( 1 - {r}^{2} )}^{2} + {( α )}^{2}}}$$

For anti-vibration problem I=1 . . . 6

$$[ Ø ] = [ {{{{{{[ Ø ]}_{1} [ Ø ]}_{2} [ Ø ]}_{3} [ Ø ]}_{4} [ Ø ]}_{5} [ Ø ]}_{6} ] \\ [ η ] = {[ \begin{matrix}{η}_{1} & {η}_{2} & {η}_{3} & {η}_{4} & {η}_{5} & {η}_{6}\end{matrix} ]}^{T} \\ [ q ] = [ Ø ] [ η ] = {[ Ø ]}_{1} {η}_{1} + {[ Ø ]}_{2} {η}_{2} + {[ Ø ]}_{3} {η}_{3} + {[ Ø ]}_{4} {η}_{4} + {[ Ø ]}_{5} {η}_{5} + {[ Ø ]}_{6} {η}_{6} = ( {[ Ø ]}_{1} {Real}_{1} + {[ Ø ]}_{2} {Real}_{2} + {[ Ø ]}_{3} {Real}_{3} + {[ Ø ]}_{4} {Real}_{4} + {[ Ø ]}_{5} {Real}_{5} + {[ Ø ]}_{6} {real}_{6} ) + j * ( {[ Ø ]}_{1} {Ima}_{1} + {{[ Ø ]}_{2} [ Ima ]}_{2} + {[ Ø ]}_{3} {Ima}_{3} + {[ Ø ]}_{4} {Ima}_{4} + {[ Ø ]}_{5} {Ima}_{5} + {[ Ø ]}_{6} {Ima}_{6} )$$

The above formula allows the conversion of displacement calculation results in separate Vector space to Oxyz coordinate system.

The response spectrum has the following form

PSDₒᵤₜ=W²PSDᵢₙ

W: Acceleration transfer function of the system or transfer function of IMU anti-vibration system

To do this, this step needs to use the following input parameters: The transfer function of the structure system after design; Weight of the structural system; Static and dynamic displacements of structures without vibration; Shock vibration spectrum.

After finishing, the transmission function of the structure system, including anti-vibration system and complete anti-vibration system, shall be obtained for testing.

### Technical Efficiency is Achieved

The sensors located in the IMU are all of a nature of “error” over time or overload that is affected during operation from the surrounding environment. This nature has a great influence on the effectiveness of the sensor whether or not it depends on the algorithm and the anti-vibration ability of the system. The force is large or small, the vibration energy is more or less causing the error of the IMU. These errors are accumulated over time from the start, so after operating for a period of time, the error will be very large. Without an anti-vibration system, this error would be uncontrollable and would easily exceed the sensor's bearing power causing damage. Based on the described passive anti-vibration system, it is easier to process signals from the inertial sensor block because the signal can be controlled within the allowed range.
After processing the results, we give 4 main indicators for the anti-vibration system of IMU:
Stiffness of anti-vibration: this criterion determines the structure's response function to vibration, helping the structure avoid resonance causing destruction.
The damping of anti-vibration: this criterion affects the amplification of the signal, the magnitude of the resonance.
Position of anti-vibration in the system: the target plays an important role in the optimization of the system.
Weight of objects: replaceable criteria depending on the anti-vibration system, perfecting the structure of the anti-vibration system

With the operation and research process of this anti-vibration system, it can be applied to the development and optimization of service projects for aircrafts.

This anti-vibration system has been used in successful tests on flying objects. Besides, some other effects are obtained as follows:
The signal received is not amplified too high, the deviation in the trajectory is not much.
Save costs and reduce time compared to buying products from abroad or transferring manufacturing technology.

The invention is described in detail by using the options described above. However, it is clear that the average person in the field of invention is not limited to the plan described in the invention description. An invention may be made in moderation or alteration mode that is not outside the scope of the invention determined by the protection claim points. So what is described in the patent description is for illustrative purposes only, and will not impose any restrictions on the invention.

1. Passive anti-vibration system for an inertial sensor block of flying instruments in a given space which is limited by a box, including a set of main components: a vibration-proof parts, a center-weighted weights, a resulting jigs. a heavy and an inertial sensor blocks, where:
anti-vibration elements are designed with a stainless steel material located in a square base and a special round rubber; wherein the anti-vibration elements have high elastic characteristics, good heat resistance, damping coefficient and appropriate stiffness;
the box is tightly attached; the anti-vibration elements are fastened to walls of the box; heavy weights and jigs connect vibration-proof components to an inertial sensor unit, which is tightened to prevent mechanical contamination as much as possible;
the components are arranged so that the weight is balanced at the center of the system, and tightly connected to the vibration-proof parts through screws and bolts.

2. The passive anti-vibration system for the inertial sensor block of the flying instruments according to claim 1 wherein the entire anti-vibration system is removable during use.

3. The passive anti-vibration system for the inertial sensor block of the flying instruments according to claim 1, wherein the system utilizes four anti-vibration components.

4. Methods of designing a anti-vibration system for inertial sensors of flight instruments includes the following steps:
Step 1: Receive anti-vibration technical requirements for inertial sensor blocks, receive IMU anti-vibration requests, learn and evaluate the value directly affecting each request, including: design space anti-vibration system: size of case (box); desired cutoff frequency; desired interference time; technical analysis of inertial sensor blocks;
Step 2: Calculate the weight of the structure including the jigs, screws and sensor blocks and calculate the transfer function of the structure without vibration; studying the transmission function of the system including jigs, inertial sensor blocks, calculating the amount of vibration that should be used, based on the principle of minimizing the impact of vibration on the inertial sensor block balance the elastic center of the system of anti-vibration components coinciding with the center of the system to be anti-vibration;
Step 3: Select appropriate anti-vibration details, based on the output data of the previous step, parameterize all values to determine the vibration resistance to be used as axial stiffness; radial stiffness; Damper coefficient depends on the material.

5. The method of designing the passive anti-vibration system for the inertial sensor block of flying devices according to claim 4, wherein at step 1, the cutoff frequency is less than 50 Hz in accordance with the given requirements so that the vibration energy is impaired after 50 Hz.
